(19) United States
(12) Patent Application Publication
(10) Pub. No.: US 2025/0386968 A1
(43) Pub. Date: Dec. 25, 2025

(54) Beverage Foaming Apparatus

(71) Applicant: Bravilor Bonamat B.V., Heerhugowaard (NL)

(72) Inventor: Lorenzo Romanus Verhoeven, Heerhugowaard (NL)

(21) Appl. No.: 19/312,134

(22) Filed: Aug. 27, 2025

Related U.S. Application Data
(63) Continuation of application No. PCT/NL2025/050022, filed on Jan. 15, 2025.

(30) Foreign Application Priority Data
Feb. 7, 2024 (NL) 2036983

(51) Int. Cl. A47J 31/52; A47J 31/44

(52) U.S. Cl. CPC A47J 31/5253; A47J 31/4485

(57) ABSTRACT

A beverage foaming apparatus, various embodiments of which may include a gas pump and a beverage pump connected to a tube which is connectable to an external beverage holder to collect and transport said beverage out of said beverage holder. The gas pump may be arranged to supply foaming gas to the tube. The beverage pump may be arranged to drive said gas together with the beverage through a restriction downstream of the beverage pump for the formation of a gas beverage foam mixture. Embodiments may include an exit line to an outlet for the gas beverage foam mixture and a first sensor downstream of the restriction to monitor the density and quality of the gas beverage foam mixture downstream of the restriction.

### CROSS-REFERENCE TO RELATED APPLICATIONS

This application is a continuation of International Application No. PCT/NL2025/050022, entitled “BEVERAGE FOAMING APPARATUS”, filed Jan. 15, 2025, which claims priority to and the benefit of Netherlands Patent Application No. 2036983, entitled “BEVERAGE FOAMING APPARATUS”, filed Feb. 7, 2024, and the specifications and claims thereof are incorporated herein by reference.

### BACKGROUND OF THE INVENTION

### Field of the Invention

Embodiments of the invention relate to a beverage foaming apparatus.

### Background

WO2023066659 discloses a device for producing milk beverages or milk foam beverages, comprising a pump, a milk intake line which is connected to the pump and is connectable to a milk reservoir, an outlet line connected to the pump, and a heating element.

EP4066700 discloses an apparatus and method for selectively producing cold, warm or hot milk foam and/or milk, the apparatus comprising at least one container for storing milk to be foamed; a fluid line; a pump, a milk intake line between the at least one container and the pump, and an outlet line between the pump and at least one outlet; wherein air is supplied into the milk intake line via an air-flow regulator, which can be arranged in an air-supply line, in order to produce a milk/air mixture upstream of the pump; wherein the milk/air mixture or the milk is conveyed through a heating element, which is designed as a flow heater and is arranged in the outlet line and is in the form of a thick-film heating element; wherein a milk foam is made from the milk/air mixture by means of a throttle device; and the milk foam or milk is dispensed at the at least one outlet.

US2018317698 discloses a device for production of milk foam with adjustable temperature, which includes a pump for conveying the milk from at least one container in lines to an outlet, an air supply for delivering air into the line, a continuous-flow heater and a throttle device. The continuous-flow heater can be disposed on the pressure side of the pump and the throttle device can be disposed downstream from the continuous-flow heater.

US2014272051 discloses a device for discharging milk and/or milk froth, including a pump to convey milk from a container, a flow-heater, and an output for discharging milk, embodied cooperating with each other such that milk conveyed via the pump and heated via the flow-heater can be discharged from the output. At least one steam generator is provided cooperating with the flow-heater such that downstream in reference to the flow-heater and upstream in reference to the output, steam can be fed to the milk for an additional heating step. An air valve to create milk froth is provided, and the air valve is openable to introduce air upstream in reference to the flow-heater.

WO2022201046 discloses beverage preparation machine comprising a mixing chamber; a milk line to supply milk from a milk container to the mixing chamber; an air line to supply air to the mixing chamber to produce foamed beverages; an air pump and a liquid pump fluidically connected to the milk line and to the air line; and an electronic control unit programmed to operate the beverage preparation machine in a washing mode, in which the liquid pump is first operated to supply a given amount of a washing liquid to the air line and the milk line, and, subsequently, the air pump is operated to supply the air line and the milk line with a given amount of pressurized air to empty the air line and the milk line of the washing liquid.

EP 2 294 952 discloses a device for dispensing milk and/or milk foam from a milk container, and in which container an extraction line is placeable, which is connected via a first line in which a pump is inserted for conveying the milk, through which first line the milk to be dispensed reaches an emulsifying device and arrives at a dispensing unit, in which emulsifying device steam can be brought in via a steam line, by which steam the milk led through the emulsifying device is frothed up and/or is heated.

US2021/0321817 discloses an apparatus for providing a milk-air emulsion. The apparatus includes: a milk line through which milk flows, a mixing chamber disposed in the milk line, an air feed system having an adjusting unit responsive to a control variable for setting an amount of air injected into the mixing chamber for producing the milk-air emulsion, a measuring unit preferably for determining the electrical conductivity of the milk-air emulsion, and a control and evaluation unit to set the control variable. In a first operating mode an amount of air, controlled by the adjusting unit, is introduced into the mixing chamber to produce the air-milk emulsion which is thereafter is dispensed. In a second operating mode a self-adjustment is performed in which the control and evaluation unit creates a data set as a function of the physical material property of the milk-air emulsion and generates the control variable based on the data set that is input to the adjusting unit.

EP 4 066 700 discloses an apparatus for selectively producing cold, warm or hot milk foam and/or milk including at least one container for storing milk to be foamed, providing a fluid and a fluid line, conveying, by a pump, a pre-definable amount of the milk to be foamed through a line system, which includes a milk intake line, between the at least one container and the pump, and an outlet line, between the pump and at least one outlet, potentially supplying air into the milk intake line via an air-flow regulator, which can be arranged in an air-supply line, in order to produce a milk/air mixture upstream of the pump, conveying the milk/air mixture or the milk through a heating element, producing a milk foam from the milk/air mixture by a throttle device; and dispensing the milk foam or milk at the at least one outlet. A conductance sensor arranged in the milk intake line, which is set up to determine the type of medium conveyed in the milk intake line by measuring a conductance, i.e. whether it is milk, fluid or water, rinsing solution or air.

Note that any citation to references herein shall not be interpreted as an admission that such references are prior art for purposes of determining the patentability of the present invention. Discussion of such references is provided for background.

### BRIEF SUMMARY OF THE INVENTION

The various embodiments of the present invention address or solve the following problems or disadvantages of prior art beverage foaming apparatuses:
Prior art (milk) frothing systems do not handle different types of milk appropriately. A prior art system often has to be set manually to properly froth a different type of milk or plant-based variant. Solutions for this are often offered in the form of multiple implementations of a system and setting each of these systems to a specific drink or type of milk.
Prior art (milk) frothing systems usually have only limited control over the temperature of the drink to be frothed due to the applied heating method (steam or flow heating element). This may result in varying foam quality.
Prior art (milk) frothing systems are often complicated to clean. Cleaning requires many steps and the use of cleaning fluids and tablets. Cleaning also often has to be done during operating hours, which causes discomfort and inconvenience.
Prior art (milk) foaming systems cannot always process different temperatures of the supplied (milk) drink. A milk carton from the refrigerator or unrefrigerated usually makes a difference in In-cup quality.
Prior art (milk) frothing systems have limited control over the milk foam quality. Even if existing systems do have accurate control this goes at the expense of having to use very expensive measuring methods. Usually the in-cup quality varies a lot due to influences like temperature, (air) pressure, degree of contamination, shelf life of the product, etc.

The various embodiments of the present invention address at least some of the above problems. Embodiments of the present invention are directed to a beverage foaming apparatus with the features of any one of the appended claims, including for example, a gas pump, a beverage pump connected to a tube which is connectable to an external beverage holder to collect and transport said beverage out of said beverage holder, said gas pump being arranged to supply foaming gas to the tube, wherein the beverage pump is arranged to drive said gas together with said beverage through a restriction downstream of the beverage pump for the formation of a gas beverage foam mixture, wherein said apparatus further comprises an exit line to an outlet for the gas beverage foam mixture

In another embodiment of the present invention, the apparatus comprises a first conductivity sensor downstream of the restriction to monitor the electrical conductivity of the gas beverage foam mixture downstream of the restriction, and comprises a second conductivity sensor upstream of the beverage pump to measure the conductivity of the beverage prior to foaming, and that an operating parameter or parameters of the beverage pump and/or the gas pump are controlled depending on a measured conductivity ratio from the first sensor and the second sensor. This provides that an optimal foam quality can be obtained due to the automatic compensation of detrimental external influencing factors, such as temperature, composition of the beverage, and other external factors since these factors are canceled out by using the conductivity ratio rather than the absolute values of the conductivity measurements of the beverage and the foam derived therefrom.

In an embodiment wherein the apparatus further comprises a heat exchanger to heat the gas beverage foam mixture, it is preferred that the apparatus comprises a first temperature sensor for monitoring a temperature of the beverage or the gas beverage foam mixture, wherein an operating parameter or parameters of the heat exchanger are controlled depending on a measurement signal from the first temperature sensor. Accordingly, the desired temperature of the beverage foam mixture can effectively be obtained. This feature can be applied separate and independent from any of the other features mentioned above or hereinafter.

It is to be noted that there are several options where the first temperature sensor can be located, firstly the first temperature sensor can be provided at a location to measure the temperature of the beverage upstream of the beverage pump. It is however also possible that the first temperature sensor is provided at a location to measure the temperature of the gas beverage foam mixture downstream of the beverage pump.

It is further desirable that the apparatus comprises a second temperature sensor for monitoring a temperature of the gas beverage foam mixture downstream of the heat exchanger, and that the operating parameter or parameters of the heat exchanger are controlled depending on a measurement signal from the second temperature sensor. This enables fine-tuning of the temperature of the beverage foam mixture coming out of the heat exchanger. This feature can be applied separate and independent from any of the other features mentioned above or hereinafter.

Beneficially the apparatus comprises an expelling pump which is arranged to be operational after a complete dosage of the beverage has been collected from the beverage container and partially, i.e. excluding the internal system volume, has been expelled as a beverage foam mixture through the outlet. The expelling pump is then operational during the last part of the dispensing, to drive the remaining beverage volume (i.e. what is left in the internal system) out of the system and out of the dispensing outlet so that any remains of the gas beverage foam mixture will leave through the exit line and outlet of the apparatus. This renders the apparatus nearly completely dry, which reduces the amount of interim cleaning of the apparatus between deliveries of successive dosages of gas beverage foam. This feature can be applied separate and independent from any of the other features mentioned above or hereinafter.

Preferably the exit line is provided with a bubble sensor, preferably in the form of a third conductivity sensor or as an optical sensor. This bubble sensor indicates the end of the supply of the gas beverage foam mixture and may be used as an initiator for an intense cleaning operation of the apparatus of the invention.

To promote an intense cleaning of the apparatus of the invention, it is desirable that the apparatus comprises a source of purifying gas downstream of the expelling pump, which source of purifying gas is operational together with the expelling pump when the bubble sensor detects sputtering of the gas beverage foam mixture or detects the passing of one or more bubbles, so that the expelling pump purges the purifying gas through the tubing of the apparatus so as to expel any beverage residue and to cleanse the tubing. The purifying/disinfecting gas can also be used to clean the system at set intervals to combat micro-organism growth. This feature can be applied separate and independent from any of the other features mentioned above or hereinafter.

Preferably the source of purifying gas is an ozone generator.

It may also be beneficial that the apparatus comprises a water inlet for flushing the apparatus with water.

Although the apparatus of the invention may be used for foaming of very different beverages, the apparatus is particularly suitable for foaming of milk, either hot milk or cold milk. The milk may also be of arbitrary origin, it may be cow milk or soy milk, or any other suitable milk that is foamable.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is an illustration showing a schematic visualization of a gas beverage foaming apparatus according to an embodiment of the present invention.

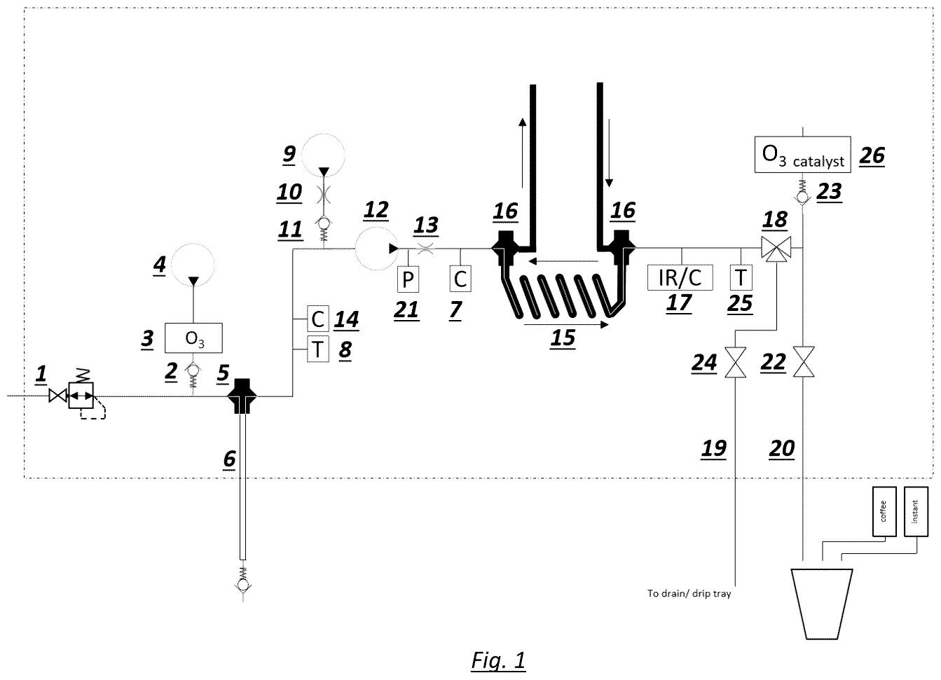

### DETAILED DESCRIPTION OF THE INVENTION

The operation of the apparatus of the invention can be explained as follows.

Milk or another drink that one wishes to froth and/or heat is sucked in from a (not shown) beverage container by a (milk) foaming pump (usually a gear pump) 12 via tube-in-tube connection 6. Use of tube-in-tube line 6 is not essential, but is preferred since this provides the possibility to easily cleanse the lines of the apparatus with water as will be explained hereinafter.

The apparatus comprises first conductivity sensor 7 downstream of restriction 13 which follows beverage pump 12 to monitor the conductivity of the gas beverage foam mixture downstream of restriction 13. Further second conductivity sensor 14 is provided upstream of beverage pump 12 to measure the conductivity of the beverage prior to foaming. Using the ratio between the measurements of first conductivity sensor 7 and second conductivity sensor 14, an operating parameter or parameters of beverage pump 12 and/or gas pump 9 are controlled depending on this measured ratio from the first sensor 7 and the second sensor 14.

The apparatus further comprises heat exchanger 15 downstream of restriction 13 to heat the gas beverage foam mixture. Preferably the apparatus further comprises first temperature sensor 8 as shown in the FIGURE for monitoring the temperature of the gas beverage foam mixture or for monitoring a temperature of the beverage. An operating parameter or parameters of heat exchanger 15 is then controlled depending on a measurement signal from first temperature sensor 8.

When heating a gas beverage foam mixture, the inlet temperature determined by temperature sensor 8, and the volume flow rate of the beverage determined in the recipe, are used to determine the required temperature and mass flow rate of the hot water which should be administered to heat exchanger 15 for heating the gas beverage foam mixture. Heat exchanger 15 is then preheated and brought to the desired temperature. When the gas beverage foam mixture comes out of heat exchanger 15, its temperature is preferably monitored by the temperature sensor (preferably a fast acting sensor with a low thermal mass). If the temperature differs from setpoint, a limited control is possible by influencing the flow and temperature of the water that is pumped through heat exchanger 15 to heat the gas beverage foam mixture. Finally downstream of heat exchanger 15, the gas beverage foam mixture passes bubble sensor (bubble/sputter detection) 17. Bubble sensor 17 can be an IR sensor or a conductivity sensor. The function of this sensor will be explained in more detail hereinafter.

The apparatus will produce a gas beverage (milk) foam mixture in a stable state until the desired dosing volume has been withdrawn from a beverage container. After this volume has been made available to the user, some remainder will still be present in the beverage (milk) foaming apparatus. At this point in the process Air Purge/Expulsion Pump 4 may be activated. The air pressure this creates in the apparatus pushes the entire remaining volume of beverage still present in the apparatus, and yet to be dispensed to the user, from the suction point at the end of tube-in-tube line 6, through the apparatus up to the dispensing point, downstream of dosing valve 18.

Expelling the remaining beverage volume from the apparatus has the advantage that the apparatus is then “dry”. The beverage (milk) is pushed through the apparatus as a column by the dispensing gas from expelling pump 4. When this column is almost completely driven through the apparatus, the separation barrier between the beverage and the gas front passes the IR or conductivity bubble sensor (bubble/spatter detection) 17. When this sensor establishes that there is no more beverage (milk) in the apparatus, the next step in the process for cleansing of the apparatus may be started. Dosing valve 18 is closed and the last milk/beverage residues are expelled with great force (pump speed of air blowing/expelling pump 4 is set at maximum). These residues are dosed through the drain or into a drip tray. The apparatus is then largely clean and can safely remain stationary for some time in this condition.

After a certain period of time has elapsed without having to dose again, the apparatus should be flushed to remove any remaining residue. Dump valve 18 is activated as well as air purge/expulsion pump 4. Water Inlet Valve (mains water) 1 is activated briefly, which introduces a column of water into the apparatus. This column is blown through the apparatus at high speed by the air pressure generated by air purge/expulsion pump 4. This water column takes with it all remaining residues and rinses them away. Finally, air purge/expulsion pump 4 is left on for some time to dry the apparatus.

The apparatus must be cleaned/sterilized periodically. For that purpose air blowing/expulsion pump 4 is switched on at low power, and source 3 for purifying gas, suitably an Ozone (O3) gas generator is also activated. Sanitizing ozone gas fills the apparatus in relatively high concentrations and binds to organic matter. Odors are neutralized and any bacterial growth is stopped. The final step is to rinse and dry the apparatus as explained above.

Embodiments of the present invention can include every combination of features that are disclosed herein independently from each other. Although the invention has been discussed in the foregoing with reference to an exemplary embodiment of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

### NOMENCLATURE

| | |
|---|---|
| 1 | Mains flush water inlet (with regulator) |
| 2 | Non return check valve |
| 3 | Ozone cleaning Gas (O3) generator |
| 4 | Cleaning air pump |
| 5 | Tube-in-tube connector |
| 6 | Tube-in-tube beverage inlet |
| 7 | Conductivity sensor |
| 8 | Temperature sensor |
| 9 | Frothing air pump |
| 10 | Air restriction |
| 11 | Non return check valve |
| 12 | Beverage (fluid) pump |
| 13 | Beverage (fluid) restriction |
| 14 | (Beverage) conductivity sensor |
| 15 | heating coil heat exchanger |
| 16 | Heat exchanger coupler |
| 17 | Infrared optical bubble detector |
| 18 | Three-way dump/dosing valve |
| 19 | Dump/drain tube outlet |
| 20 | Beverage dispensing outlet |
| 21 | (Foam) pressure sensor |
| 22 | Two-way beverage dispense valve |
| 23 | Non return check valve (ozone) |
| 24 | Two-way dump/drain valve |
| 25 | (foam) temperature sensor |
| 26 | Ozone gas catalyst |

What is claimed is:

1. A beverage foaming apparatus comprising:
a gas pump;
a beverage pump connected to a tube which is connectable to an external beverage holder to collect and transport said beverage out of said beverage holder, said gas pump arranged to supply foaming gas to the tube, wherein the beverage pump is arranged to drive said gas together with said beverage through a restriction downstream of the beverage pump for the formation of a gas beverage foam mixture;
an exit line to an outlet for the gas beverage foam mixture;
a first conductivity sensor downstream of the restriction to monitor the electrical conductivity of the gas beverage foam mixture downstream of the restriction; and
a second conductivity sensor upstream of the beverage pump to measure the conductivity of the beverage prior to foaming, wherein an operating parameter or parameters of the beverage pump and/or the gas pump are capable of being controlled depending on a measured conductivity ratio from the first sensor and the second sensor.

2. The beverage foaming apparatus according to claim 1 further comprising:
a heat exchanger to heat the gas beverage foam mixture; and
a first temperature sensor for monitoring a temperature of the beverage or the gas beverage foam mixture, wherein an operating parameter or parameters of the heat exchanger are capable of being controlled depending on a measurement signal from the first temperature sensor.

3. The beverage foaming apparatus according to claim 2, wherein the first temperature sensor is disposed at a location to measure the temperature of the beverage upstream of the beverage pump.

4. The beverage foaming apparatus according to claim 2, wherein the first temperature sensor is disposed at a location to measure the temperature of the gas beverage foam mixture downstream of the beverage pump.

5. The beverage foaming apparatus of claim 3 further comprising:
a second temperature sensor for monitoring a temperature of the gas beverage foam mixture downstream of the heat exchanger, wherein the operating parameter or parameters of the heat exchanger are capable of being controlled depending on a measurement signal from the second temperature sensor.

6. The beverage foaming apparatus according to claim 1 further comprising:
an expelling pump arranged to be operational after a complete dosage of the gas beverage foam mixture has left the outlet, which expelling pump is then operational for driving out any remains of the gas beverage foam mixture through the exit line and outlet of the apparatus.

7. The beverage foaming apparatus according to claim 1, wherein the exit line comprises a bubble sensor.

8. The beverage foaming apparatus according to claim 7 further comprising:
a source of purifying gas downstream of the expelling pump, which source of purifying gas is operational together with the expelling pump when the bubble sensor detects sputtering of the gas beverage foam mixture or detects the passing of one or more bubbles, so that the expelling pump purges the purifying gas through the tubing of the apparatus so as to expel any beverage residue and to cleanse the tubing.

9. The beverage foaming apparatus according to claim 8, wherein the source of purifying gas is an ozone generator.

10. The beverage foaming apparatus according to claim 1 further comprising a water inlet for flushing the apparatus with water.

11. The beverage foaming apparatus according to claim 1, wherein the apparatus is arranged to foam milk.

12. The beverage foaming apparatus of claim 4 further comprising:
a second temperature sensor for monitoring a temperature of the gas beverage foam mixture downstream of the heat exchanger, wherein the operating parameter or parameters of the heat exchanger are capable of being controlled depending on a measurement signal from the second temperature sensor.
